(19) United States
(12) Patent Application Publication
(10) Pub. No.: US 2010/0326971 A1
(43) Pub. Date: Dec. 30, 2010

(54) THERMAL BARRIER COATING REMOVAL VIA SHOCKWAVE STRESSES

(75) Inventors: David A. HELMICK, Fountain Inn, SC (US); David Leslie Burin, Greer, SC (US)

Correspondence Address: NIXON & VANDERHYE P.C., 901 NORTH GLEBE ROAD, 11TH FLOOR, ARLINGTON, VA, 22203, US

(73) Assignee: General Electric Company, Schenectady, NY (US)

(21) Appl. No.: 12/494,626

(22) Filed: Jun. 30, 2009

(51) Int. Cl. B23K 26/38

(52) U.S. Cl. 219/121.69

(57) ABSTRACT

A method for removing a thermal barrier coating on a surface of a machine component, the method comprising the steps of arranging plural shockwave generators so as to focus shockwave energy on a target area of the machine component; and subjecting the target area of the thermal barrier coating to plural focuses shockwaves such that the thermal barrier coating is caused to delaminate and can be removed from the machine component.

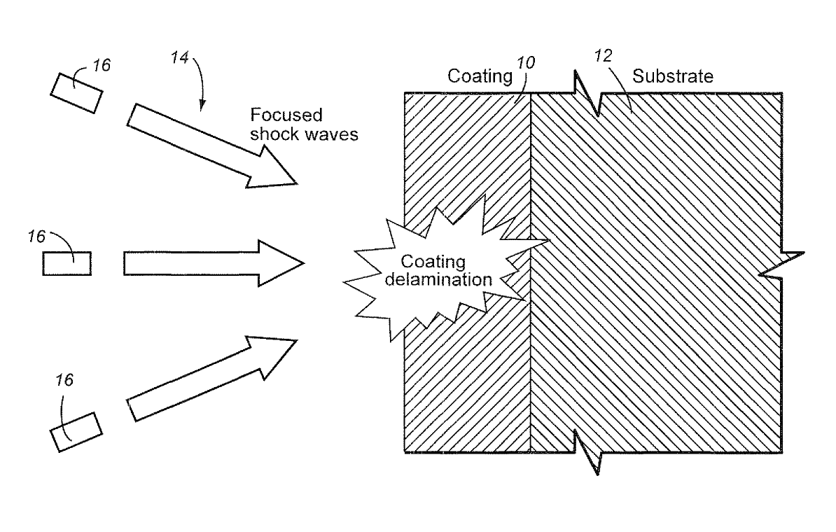

### BACKGROUND OF THE INVENTION

This invention generally relates to protective coatings for metal alloy components exposed to high temperature gas environments and severe operating conditions, such as the working components of gas turbine engines used in electric power generation. More particularly, the invention relates to the removal of coatings on one or more surfaces of the turbine component.

The operating conditions to which gas turbine hardware components are exposed may be thermally and chemically severe. The surfaces of the metal substrates used to form turbine, combustor and augmentor components should exhibit greater than average mechanical strength, durability and erosion resistance in a very hostile, high temperature gas environment. “Erosion” generally refers to the process whereby a surface, particularly metal, is bombarded by contaminant particles of sufficiently high energy that cause other particles to be ejected (eroded) from the surface, resulting in degradation and cracking of the substrate material.

Recent advances have been achieved by using high temperature alloys in gas turbine systems by incorporating iron, nickel and cobalt-based superalloys in coatings applied to the substrate of key turbine components.

Many of the known prior art coatings used for gas turbine components include aluminide and ceramic materials. Typically, ceramic coatings have been used in conjunction with a bond coating formed from an oxidation-resistant alloy such as MCrAlY, where M is iron, cobalt, and/or nickel, or from a diffusion aluminide or platinum aluminide that forms an oxidation-resistant intermetallic. In higher temperature applications, these bond coatings form an oxide layer or “scale” that chemically bonds to the ceramic layer to form the final bond coating.

It has also been known to use zirconia (ZrO₂) that is partially or fully stabilized by yttria (Y₂O₃), magnesia (MgO) or other oxides as the primary constituent of the ceramic layer. Yttria-stabilized zirconium (YSZ) is often used as the ceramic layer for thermal bond coatings because it may exhibit favorable thermal cycle fatigue properties. That is, as the temperature increases or decreases during gas turbine start up and shut down, the YSZ is capable of resisting stresses and fatigue much better than other known coatings. Typically, the YSZ is deposited on the metal substrate using known methods, such as air plasma spraying (APS), low pressure plasma spraying (LPPS), as well as by physical vapor deposition (PVD) techniques such as electron beam physical vapor deposition (EBPVD), Notably, YSZ deposited by EBPVD is characterized by a strain-tolerant columnar grain structure that enables the substrate to expand and contract without causing damaging stresses that lead to spallation. The strain-tolerant nature of such systems may be known. See generally U.S. Pat. No. 6,730,413 for a description of a known thermal barrier coating system.

After application, the coating may be selectively cracked, i.e., micro-cracks may be formed in the coating using shockwave exposure for the purpose of inducing strain tolerance.

Laser peening has also been used to create a compressively stressed protection layer at the outer surface of a turbine component which is known to considerably increase its resistance to fatigue failure as described in U.S. Pat. No. 4,937,421. Laser shock peening has also been used create deep compressive residual stresses into a turbine blade as described in U.S. Pat. No. 5,591,009.

During the repair of turbine components, however, the removal of the entire coating is often required. Typically, the coating is removed by a manual or automatic grit blasting, water jets or other similar time-consuming process.

There remains a need, therefore, for a quick and reliable process for removing a TBC or other coating from a machine component to facilitate repair of the component.

### BRIEF DESCRIPTION OF THE INVENTION

In an exemplary but nonlimiting embodiment, there is provided a method for removing a coating on a surface of a machine component, the method comprising the steps of arranging plural shockwave generators so as to focus shockwave energy on a coated target area of the machine component; and subjecting the coated target area of the thermal barrier coating to plural focused shockwaves such that the coating is caused to delaminate and separate from the surface of the machine component.

In another aspect, the invention relates to a method for removing a coating on a surface of a machine component, the method comprising the steps of (a) arranging plural shockwave generators in proximity to a target area of the machine component; and (b) subjecting the target area to plural focused shockwaves such that the coating is caused to delaminate and separate from the surface of said machine component wherein step (b) is carried out by at least one of: a laser wave-generating process, an ultrasound wave-generating process, an electric field wave-generaling process and any combination thereof.

The invention will now be described in greater detail in connection with the single drawing identified below.

### BRIEF DESCRIPTION OF THE DRAWING

The FIGURE is a partially-schematic cross-sectional view of a metal substrate, such as a high pressure gas turbine blade, showing removal of a coating in accordance with an exemplary but nonlimiting embodiment of the invention.

### DETAILED DESCRIPTION OF THE INVENTION

As noted above, coatings are often applied to the surfaces of various metal alloy machine components (so-called “superalloys” that must be protected from thermally and chemically hostile environments. Examples of such machine components include nozzles, buckets, and other hardware found in the hot gas path of, for example, a gas turbine engine.

The coating may be a TBC of any known composition, e.g., it may consist of a thermal insulating ceramic layer whose composition and deposition significantly enhance the erosion resistance of the turbine components while maintaining a spallation resistance equivalent to or better than conventional coatings.

High pressure turbine blades are prime examples of the substrates to which TBCs are applied but which must oftentimes be removed to facilitate repair of the blade. Typically, turbine blades have an airfoil and a platform against which hot combustion gases are directed during operation of the gas turbine. The airfoil surfaces are subjected to attack by oxidation, corrosion, and erosion. The airfoil normally is anchored to a turbine disk with a dovetail formed on a root section of the blade, with the platform located between the airfoil and the dovetail.

The sole drawing FIGURE shows a thermal barrier coating (TBC) 10 applied to a substrate 12. The coating 10 may include a thermal-insulating ceramic layer over a bond coating (not shown) that overlies the metal alloy substrate 12 which may form the base material of the turbine blade or other turbine component. Suitable materials for the substrate include iron-, nickel-, and/or cobalt-based superalloys. The bond coating may be oxidation resistant and may form an alumina layer on the surface of the bond coating when the coated blade is exposed to elevated temperatures. The alumina layer may protect the underlying superalloy substrate 12 from oxidation and may provide a surface to which the ceramic layer adheres.

In an exemplary embodiment, a strain tolerant TBC may be formed using laser shock peening. The TBC may be applied to a metal substrate using an air plasma spray. If a bond coat is employed, it may be MCrAlY (where M is iron, cobalt, and/or nickel), and the TBC itself may be 8% yttria-stabilized zirconia or any other ceramic-based coating typically used in TBCs. After application to the substrate, the TBC may be laser shock peened.

In order to effect removal of the coating 10 from the substrate 12 as part of a repair procedure for example, focused shockwave energy is employed.

More specifically, in an exemplary but nonlimiting embodiment, a single pulse of multiple, focused shockwaves 14, at a selected energy level sufficient to delaminate and remove the coating 10 but insufficient to deform or otherwise damage the underlying substrate 12, is directed at the coating. The source of the shockwaves may vary. For example, wave pulses generated by known techniques such as laser, sound, ultrasound (as in lithotripsy procedures used to break up kidney stones), electromagnetic field, or other coupled ablation techniques etc. (or combination thereof) are suitable for carrying out the invention. Multiple wave-generating sources 16 may be set up in proximity to the coating or target surface to facilitate focusing the waves on the desired location or target surface. While coating removal may be achieved with a single pulse of the focused shockwaves, the invention contemplates multiple pulses if needed or otherwise desired. The shockwaves striking the component surface or target area will delaminate or separate from the underlying substrate quickly and efficiently.

While the invention has been described in connection with what is presently considered to be the most practical and preferred embodiment, it is to be understood that the invention is not to be limited to the disclosed embodiment, but on the contrary, is intended to cover various modifications and equivalent arrangements included within the spirit and scope of the appended claims.

What is claimed is:

1. A method for removing a coating on a surface of a machine component, the method comprising the steps of:
(a) arranging plural shockwave generators in proximity to a target area of the machine component; and
(b) subjecting the target area to plural focused shockwaves such that the coating is caused to delaminate and separate from the surface of said machine component.

2. The method of claim 1, wherein the machine component comprises a gas turbine component.

3. The method of claim 2 wherein said gas turbine component comprises a gas turbine blade.

4. The method of claim 1, wherein said coating comprises a yttria-stabilized zirconium thermal barrier coating.

5. The method of claim 1, wherein the step of subjecting the target area to plural focused shockwaves comprises a laser wave-generating process.

5. The method of claim 1, wherein the step of subjecting the target area to plural focused shockwaves comprises an ultrasound wave-generating process.

6. The method of claim 1, wherein the step of subjecting the target area to plural focused shockwaves comprises an electric field wave-generating process.

7. The method of claim 1 wherein during step (b), a single pulse of focused shockwaves is generated.

8. A method for removing a coating on a surface of a machine component, the method comprising the steps of:
(a) arranging plural shockwave generators in proximity to a target area of the machine component;
(b) subjecting the target area to plural focused shockwaves such that the coating is caused to delaminate and separate from the surface of said machine component; and
wherein step (b) is carried out by at least one of: a laser wave-generating process, an ultrasound wave-generating process, an electric field wave-generaling process and any combination thereof.

9. The method of claim 8 wherein a method of claim 1 wherein during step (b), a single pulse of focused shockwaves is generated.
